(19) United States
(12) Patent Application Publication
(10) Pub. No.: US 2015/0254994 A1
(43) Pub. Date: Sep. 10, 2015

(54) ATHLETE MENTAL STRENGTH ASSESSMENT AND CONDITIONING SYSTEM AND METHOD

(71) Applicant: Mara D.H. Smith, Lake Placid, NY (US)

(72) Inventor: Mara D.H. Smith, Lake Placid, NY (US)

(21) Appl. No.: 14/640,508

(22) Filed: Mar. 6, 2015

Related U.S. Application Data
(60) Provisional application No. 61/949,710, filed on Mar. 7, 2014.

(51) Int. Cl. G09B 7/06; G06F 3/0484

(52) U.S. Cl. CPC G09B 7/06; G06F 3/04842; G06F 3/04847

(57) ABSTRACT

A computer-based tool assesses an athlete's mental strength to allow the athlete to condition their mind and body for athletic performance. Users engage the tool to self-evaluate one's own mental status after one of three modes. These modes are training, competing and resting.

### PRIORITY AND RELATED APPLICATION

This application claims priority to U.S. Provisional Patent Application Ser. No. 61/949,710, filed Mar. 7, 2014, entitled “Athlete Mental Strength Assessment and Conditioning System and Method”, which is hereby incorporated by reference in its entirety.

### FIELD OF THE INVENTION

The present invention relates to computer systems for assessing mental strength of athletes in order to condition athletes.

### BACKGROUND OF THE INVENTION

Ninety-nine percent of athletes acknowledge that there is a mental component to their sport. Eighty percent of athletes have a physical strength and conditioning plan. However only five percent of athletes have a mental strength and conditioning plan. Accordingly a tool or system and method is need to help integrate athlete's mental skills into training and performance. Building mental strength translates into some of the most critical dimensions in sports: consistency and confidence. A device is further needed that will help athletes develop and utilize a mental strength and conditioning plan to optimize their physical training. A tool is further needed that is appropriate for all athlete, of all abilities, in all sports, who want to improve their performance.

The tool should track a spectrum of mental skills required for optimization of athletic performance. Such a tool should be simple and fast, and provides athletes with essential data for improvement. The tool should keep track of an athlete's data and impart information that allows the athlete to train smarter, rest effectively, and compete effectively at the top of one's game.

### DESCRIPTION OF THE DRAWINGS

FIG. 1 shows a screenshot of the athlete mental strength assessment and conditioning tool of the present invention showing the three modes employed with the invention.

FIG. 2 shows screenshot to create a profile in the tool described in the present invention.

FIG. 3 shows a screenshot for a competition mode employed with the tool described in the present invention where a user answers a performance question with a low rating.

FIG. 4 shows a screenshot for a competition mode employed with the tool described in the present invention where a user answers a performance question with a middle performance rating.

FIG. 5 shows a screenshot for a competition mode employed with the tool described in the present invention where a user answers a performance question with a high performance rating.

FIG. 6 shows a reporting screenshot of the tool described in the present invention.

### DESCRIPTION OF THE INVENTION

A computer-based tool assesses an athlete's mental strength to allow the athlete to condition their mind and body for athletic performance. Users engage the tool to self-evaluate one's own mental status after one of three modes. These modes are training, competing and resting. Once a mode is selected the user is provided with questions specific to the mode. Athletes answer the questions and the data acquired in answering the questions are assessed and reported. The assessment interprets the athletes performance with respect to the mode selected.

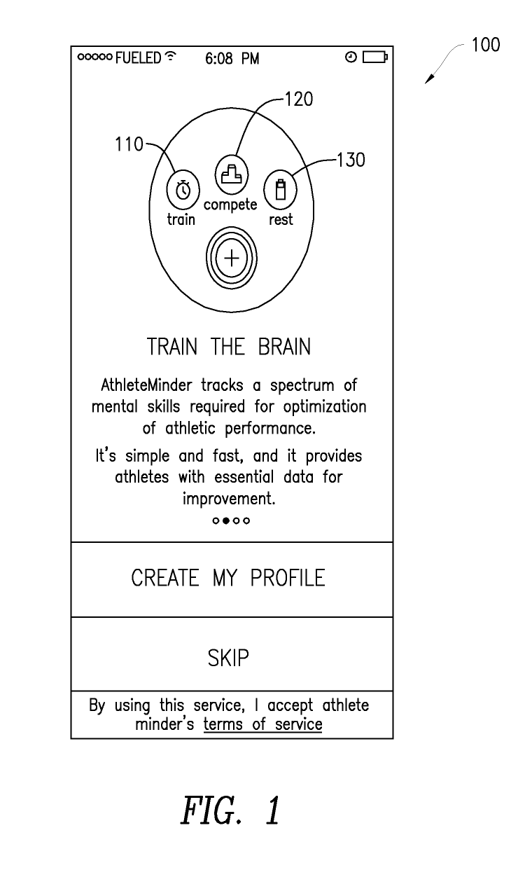

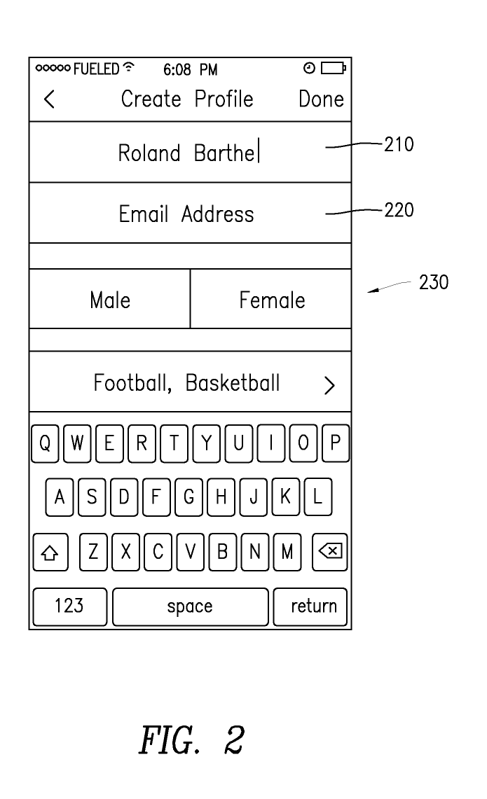

A user who has already logged in and is a member of the tool 100 engages the tool 100 by selecting one of three modes to analyze. FIG. 1 shows the three modes employed with the tool 100. These modes are train 110, compete 120 and rest 130. Each mode will contain a set of questions that the athlete will answer after training, after competing or after resting. The questions can usually be answered in a short period of time such as three minutes. FIG. 2 shows details of a create profile screen that allows first-time users to create a profile and use the tool 100. Here the user fills in their name 210, email address 220, gender 230, sport and level of play (not shown).

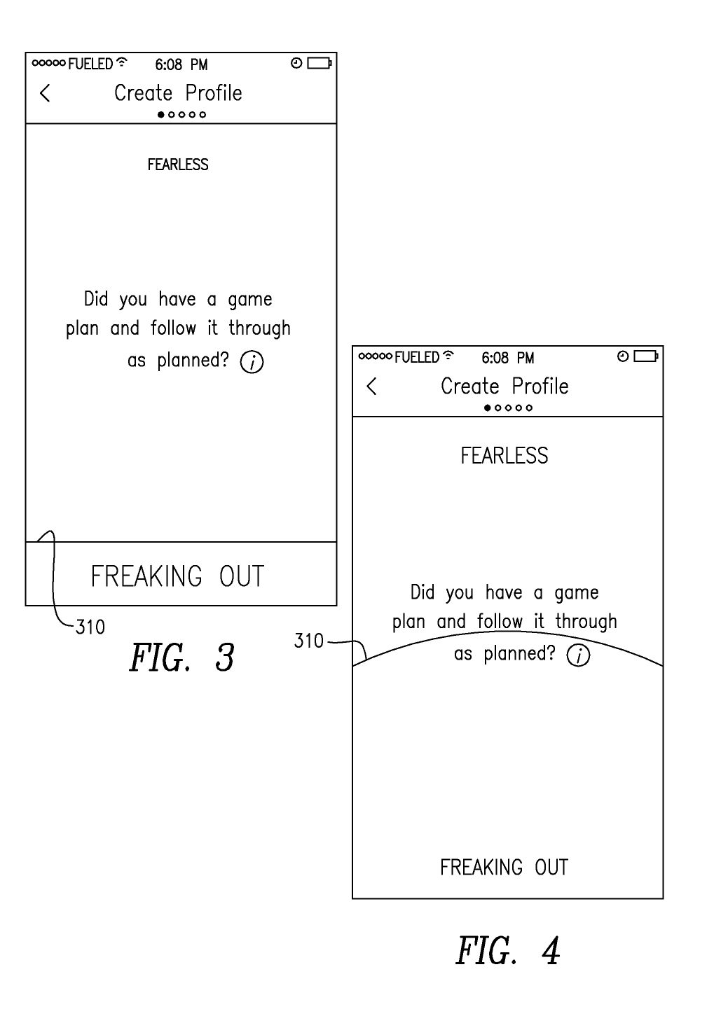

FIGS. 3-5 show a user interacting with the competition mode 120 of the tool 100. Competition mode 120 records the user's response to questions tailored to the user's mental state after participating in a competition and then compares the current results against the user's last workout or competition.

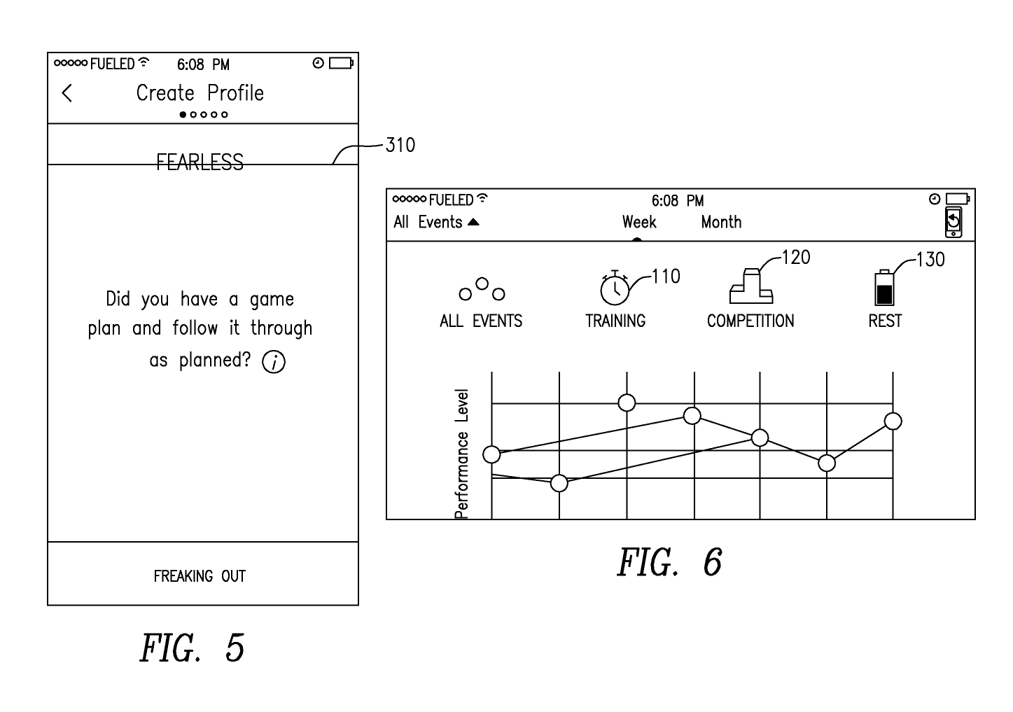

FIG. 3 shows an model question posed to a user “Did you have a game plan and follow it through as planned?” The user answers the question by rating her performance from low to high. Low performance is indicated by leaving bar 310 at the bottom of the screen to indicate a performance feeling of “freaking out.” The user can use their finger to drag bar 310 up to a middle performance level, see FIG. 4 to show the user rated herself somewhere between “freaking out” and “fearless.” Finally if the user felt she had a game plan and followed it through she can continue to drag the bar 310 up to the top of the screen where the word “fearless” will be shown, see FIG. 5.

As the user manipulates the bar to answer the question the user will be moving the bar from a value of 0 at the “freaking out” level to a maximum value of 10 at the “fearless” level. The value is determined by how high the user pulls the bar. When the user answers a mental skills question by sliding the colored bars up or down, a quantitative value is recorded in the background. A number or value is assigned at the place the user stops to rate themselves. In other embodiments, the tool may collate data in certain areas to produce other specialized reporting. The answers to the competitive mode questions will be assessed for competitive mindset, competitive reality, competitive energy, nutrition and sleep.

Though not shown, similar screenshots would be employed with the train 110 and rest 130 modes. In train 110 mode, the user may answer question such as but not limited to “How focused were you during your training session?” The user would then rate his performance by selecting between “Distracted” to indicate low focus to “Keyed In” to indicate high focus or some middle ground. Training mode assessments would evaluate areas such as plan of action, focus during practice, performance (“how did I train?”), nutrition and sleep.

Likewise, in rest mode 130, the user may answer question such as but not limited to “How did you feel when waking up in the morning?” The user would then answer by selecting between a rating of “Spent” to indicate low rest state to “Strong” to indicate high rest state or some middle ground. Rest mode assessments would evaluate areas such as woke up feeling, ate and felt, able to unwind, nutrition and sleep. At the end of fulfilling each mode an event report is created for the day. The output provided is based on the aggregated value derived from the user's answers to all mental skills question each day.

Assessment and Reports

Looking now to FIG. 6, data provided in event reports from each of the three modes are collected at the end of each day to get a daily summary that provides results analyzed over time for each mode. All data is stored securely in a database. The results may be provided in bar graphs or other forms to allow the user to visually observe and analyze patterns over time such as week or month or year, etc. for each mode individually or all three modes at once.

Create An Event and Prompts to Enter Data

The user can create an event on a specific date for one of the three modes. Looking back at FIG. 1, the user will drag one of the three modes, 110, 120 or 130 into field 102 and create the desired mode. The user will be prompted to complete questions in an Event Report in a specific mode once the event (competition, training, rest) has passed. If the user chooses to fill it out there and then, they will be taken to the mode requiring user input. Alternatively the user can opt to fill out the Report at a later date, and the date on the calendar will be marked to highlight that the report needs filling out. Assistance is provided to the user at each step of the way especially with regard to responding to inquiries in each mode.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A mental strength assessment system comprising:
a computer-enabled input and display device; interactive screens displayed on the device that permit a user of the system to provide
responses to questions regarding the user's mental status during different modes that are displayed on the screens;
a processor for assessing the responses to questions and generating a report regarding the responses that can be displayed on the screens.

2. The system of claim 1 wherein the modes consist of at least one of training, competing and resting.

3. The system of claim 1 wherein the interactive screens require the user to answer questions by sliding a touchpoint on the screen up and down to indicate more or less
positive answers to the questions.

4. The system of claim 3 wherein the screen displays short answers to the questions at the top and bottom of the screen.

5. The system of claim 1 wherein the processor assigns a numeric rating to the responses provided by the user for use in assessing the responses.

6. The system of claim 5 wherein the report displayed on the screen is in the form of a chart.

7. The system of claim 6 wherein the responses collected from the user each day are assessed and displayed in a daily report.

8. The system of claim 1 wherein the user can create an event on a specific date to collect the user's responses during one or more modes.

9. The system of claim 2 wherein the user is an athlete.

10. The system of claim 2 wherein the mode is competition and the responses to the questions will be assessed for competitive mindset, competitive reality, competitive energy, nutrition and sleep.

11. The system of claim 2 wherein the mode is training and the responses to the questions will be assessed for plan of action, focus during practice, performance,
nutrition and sleep.

12. A mental strength assessment method implemented on a computer-enabled input and display device comprising:
displaying on a screen on the device questions regarding the user's mental status during different modes;
providing a touch-sensitive area on the screen to permit the user to touch the screen and indicate the user's responses to the questions;
processing the responses to questions and generating a report regarding the responses that can be displayed on the screens.

13. The method of claim 12 wherein the modes consist of at least one of training, competing and resting.

14. The method of claim 12 further comprising requiring the user to answer questions
by sliding a touchpoint on the screen up and down to indicate more or less positive answers to the questions.

15. The method of claim 14 further comprising displaying on the screen short answers to the questions at the top and bottom of the screen.

16. The method of claim 12 further comprising assigning a numeric rating to the responses provided by the user for use in assessing the responses.

17. The method of claim 16 further comprising displaying the report on the screen is in the form of a chart.

18. The method of claim 15 further comprising assessing and displaying all the responses collected from the user each day in a daily report.

19. The method of claim 12 further comprising creating event on a specific date that collects the user's responses during one or more modes.

20. The method of claim 13 wherein the user is an athlete.
